(19) United States
(12) Patent Application Publication
(10) Pub. No.: US 2015/0223184 A1
(43) Pub. Date: Aug. 6, 2015

(54) Timing Advance Timer Start for Uplink Transmissions

(71) Applicants: Mattias Tan Bergström, Stockholm (SE); Niklas Johansson, Sollentuna (SE)

(72) Inventors: Mattias Tan Bergström, Stockholm (SE); Niklas Johansson, Sollentuna (SE)

(73) Assignee: Telefonaktiebolaget L M Ericsson (publ), Stockholm (CH)

(21) Appl. No.: 14/419,730

(22) PCT Filed: Aug. 6, 2012
(86) PCT No.: PCT/SE2012/050861

§ 371 Date: Feb. 5, 2015

(51) Int. Cl. H04W 56/00; H04W 24/06; H04W 72/04

(52) U.S. Cl. CPC H04W 56/0045; H04W 72/0446; H04W 24/06

(57) ABSTRACT

Embodiments herein include a method implemented by a wireless communication device (14) in a wireless communication network (14) that comprises a plurality of cells (24). The method comprises forming a timing advance group (32) to include one or more cells (24) on which to perform uplink transmissions using the same uplink transmission timing, including initializing a timing advance value (28) defining said uplink transmission timing. The method also comprises, while forming the timing advance group (32), or responsive to receiving an initial uplink grant on a downlink control channel allocating uplink resources on a cell (24) in the timing advance group (32), selectively starting a timing advance timer (30). Finally, the method comprises performing uplink transmissions on the cells (24) in the timing advance group (32), according to the initialized timing advance value (28), provided that the timing advance timer (30) has not expired.

### TECHNICAL FIELD

The present invention generally relates to a wireless communication device performing uplink transmissions on one or more cells in a wireless communication network, and particularly relates to the starting of a timing advance timer for those uplink transmissions.

### BACKGROUND

A wireless communication network comprises a plurality of radio access nodes that communicate with wireless communication devices. Each radio access node terminates one or more cells on which transmissions are performed for communicating with the devices. A cell in this regard refers to a defined set of radio resources, such as a carrier frequency, for wirelessly communicating over a defined geographic region. For example, a wireless communication network conforming to Long Term Evolution (LTE) Release 11 specifications comprises a plurality of enhanced Node B's (eNodeB's) that each terminates one or more cells (also referred to as component carriers).

In order to preserve orthogonality between different devices in the uplink, any given radio access node must receive uplink transmissions on a cell from those different devices at approximately the same time (i.e., time-aligned). Because the different devices may be located at different distances from the radio access node or otherwise have different round trip times to the node, the devices may need to initiate their respective uplink transmissions on the cell at different times, so that the transmissions arrive at the radio access node at approximately the same time (e.g., within a cyclic prefix). To this end, a device times uplink transmissions on a cell terminated by the radio access node according to a so-called timing advance value. This timing advance value defines an amount of time that the device advances uplink transmission timing on a cell relative to a specified timing reference (e.g., relative to downlink reception timing). By setting different timing advance values for devices having different round trip times to the radio access node, the node ensures that the uplink transmissions of those devices will arrive at the node time-aligned.

A radio access node initializes the timing advance value for a device during a random access procedure (before timing advance value is initialized, its value is undefined). Specifically, the device performs a random-access uplink transmission (e.g., by transmitting a random-access preamble) on a cell terminated by the node, under an assumption that the timing advance value will be initialized to zero. The node performs timing measurements on this random-access transmission in order to determine how to actually initialize the timing advance value for the device and then signals the determined value to the device in a random access response. The device initializes the timing advance value responsive to this signaling, and performs subsequent uplink transmissions, including non-random-access transmissions such as user data transmissions, according to the initialized timing advance value.

The timing advance value, however, may become stale or otherwise inaccurate under certain circumstances, such as when the device moves to a different location or when the round trip time to the radio access node changes. Accordingly, when the device initializes the timing advance value responsive to the random access response, the device starts a so-called timing advance timer. So long as the timing advance timer has not expired, the device considers the timing advance value to be accurate and performs non-random-access uplink transmissions according to that value. The radio access node may perform timing measurements on these uplink transmissions and signal timing advance value updates to the device as needed (e.g., via a Medium Access Control (MAC) Control Element (CE)), whereupon the device updates the timing advance value and restarts the timing advance timer without having to perform another random access transmission. But, if the timing advance timer expires before receiving a timing advance value update, the device must perform another random access transmission and re-initialize the timing advance value before it can perform any non-random-access transmission.

Some contexts complicate this uplink transmission time alignment process. In particular, any given wireless communication device can perform uplink transmissions on multiple cells at the same time, e.g., by employing carrier aggregation. When these multiple different cells are terminated at the same radio access node, are in the same frequency band, are relayed by the same number of repeaters, and are otherwise associated with the same round trip time, the device performs the uplink transmissions according to the same timing advance value. However, when at least some of the multiple different cells are associated with a different round trip time, the device may need to perform the uplink transmissions on those cells according to different timing advance values. Accordingly, the device maintains different timing advance values and corresponding timing advance timers for different groups of cells, referred to as timing advance groups. Uplink transmissions are performed on the cells in any given timing advance group according to the timing advance value maintained for that group, provided that the corresponding timing advance timer has not expired.

### SUMMARY

One or more embodiments herein advantageously improve the uplink transmission time alignment process as compared to known approaches, by optimizing associated control signaling and/or reducing the delay between when a timing advance group is formed and when a wireless communication device can perform non-random-access uplink transmissions on the cells in that group. Some embodiments, for example, improve the time alignment process by starting the timing advance timer for a timing advance group at a different time and/or in a different way than known approaches. Other embodiments improve the time alignment process by permitting select non-random-access uplink transmissions on the cells in a group even prior to the start of the timing advance timer.

More particularly, embodiments herein include a method implemented by a wireless communication device in a wireless communication network that comprises a plurality of cells. The method comprises forming a timing advance group to include one or more cells on which to perform uplink transmissions using the same uplink transmission timing, including initializing a timing advance value defining said uplink transmission timing. The method also comprises, while forming the timing advance group, or responsive to receiving an initial uplink grant on a downlink control channel allocating uplink resources on a cell in the timing advance group, selectively starting a timing advance timer. Finally, the method comprises performing uplink transmissions on the cells in the timing advance group, according to the initialized timing advance value, provided that the timing advance timer has not expired.

In at least some embodiments, this forming comprises creating a data structure to represent the timing advance group. In this case, such selective starting may comprise selectively starting the timing advance timer while forming the timing advance group, by selectively starting the timing advance timer responsive to either: receiving a command from the wireless communication network to create said data structure; creating said data structure; or sending acknowledgement to the wireless communication network that said data structure has been created.

In other embodiments, group formation comprises including the one or more cells in the timing advance group. In this case, such selective starting may comprise selectively starting the timing advance timer while forming the timing advance group, by selectively starting the timing advance timer responsive to including the one or more cells in the timing advance group.

In still other embodiments, the method further comprises, while forming the timing advance group, receiving one or more uplink grants allocating uplink resources on one or more cells in the timing advance group. In this case, such selective starting may comprise selectively starting the timing advance timer while forming the timing advance group, by selectively starting the timing advance timer responsive to receiving said one or more uplink grants. In at least one embodiment, for example, the one or more uplink grants are received in a command to create a data structure to represent the timing advance group. In an alternative embodiment, though, the one or more uplink grants are received in one or more messages that indicate one or more cells to include in the timing advance group.

In yet other embodiments, selectively starting the timing advance timer comprises selectively starting the timing advance timer responsive to receiving said initial uplink grant over a downlink control channel. In this case, the timing advance timer is selectively started either when said initial uplink grant is received, or when a time occurs at which uplink transmissions are to be performed in accordance with the received initial uplink grant.

In one or more embodiments, selectively starting the timing advance timer comprises starting the timing advance timer if one or more defined conditions are met indicating that said initialization of the timing advance value is reliable. In this case, the one or more defined conditions may comprise one or more of: the timing advance value being initialized as a value in a subset of possible values defined to be reliable; and the timing advance value being initialized according to a rule in a defined subset of possible rules defined to yield reliable initialization.

In one or more other embodiments, selectively starting the timing advance timer comprises starting the timing advance timer if one or more defined conditions are met indicating that uplink transmissions on one or more cells included in the timing advance group are sensitive to delay. In this case, the one or more defined conditions may comprise the wireless communication device having already been configured, prior to formation of the timing advance group, to perform uplink or downlink transmissions on at least one cell included in the timing advance group. Alternatively, the one or more defined conditions may comprise the wireless communication device using a service in a subset of possible services defined to be delay sensitive. As another alternative, the one or more defined conditions may comprise an amount of data in a buffer for said uplink transmissions exceeding a defined threshold.

In still other embodiments, the method comprises receiving a command from the wireless communication network indicating whether or not the wireless communication device is to start the timing advance timer while forming the timing advance group or responsive to said initial uplink grant. In this case, such selective starting comprises starting the timing advance timer in accordance with the received command.

Embodiments herein also include a corresponding method performed by a radio access node for sending such a command to the device. In one or more embodiments, for example, the method includes generating one or more messages associated with formation by the wireless communication device of a timing advance group that includes one or more cells on which to perform uplink transmissions using the same uplink transmission timing. This includes generating at least one of said messages to explicitly or implicitly indicate whether or not the wireless communication device is to start a timing advance timer while forming the timing advance group. The method then includes sending the one or more generated messages to the wireless communication device.

In at least some embodiments, this generation further comprises generating said at least one message to also indicate at least one of: that the device is to create a data structure to represent the timing advance group; and that one or more cells are to be included in the timing advance group.

Moreover, in some embodiments, this generating comprises generating said at least one message to implicitly indicate whether or not the wireless communication device is to start the timing advance timer while forming the timing advance group, by generating said at least one message to explicitly indicate that the timing advance group is to be assigned an identifier in a subset of possible identifiers defined for indicating when the timing advance timer is to be started. Alternatively, the at least one message is generated to explicitly indicate that the timing advance timer is to have a duration in a subset of possible durations defined for indicating when the timing advance timer is to be started. As yet another alternative, the at least one message is generated to explicitly indicate that uplink resources are allocated to the wireless communication device on a cell in the timing advance group.

Embodiments herein further include another method implemented by a wireless communication device. The method entails forming a timing advance group to include one or more cells on which to perform uplink transmissions using the same uplink transmission timing. The method also comprises, prior to the start of a timing advance timer, performing non-random-access uplink transmissions on one or more cells in the timing advance group to assist the wireless communication network in determining said uplink transmission timing. Finally, the method comprises, after the start of the timing advance timer, performing uplink transmissions on the cells in the timing advance group according to the determined uplink transmission timing, provided that the timing advance timer has not expired.

In at least some embodiments, performing non-random-access uplink transmissions comprises transmitting a channel-sounding reference signal.

Finally, embodiments herein include a wireless communication device and a radio access node configured to perform the methods described above.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a wireless communication network that includes a wireless communication device and a radio access node configured according to one or more embodiments.

FIG. 2 is a logic flow diagram of a method implemented by a wireless communication device in the wireless communication network of FIG. 1, according to one or more embodiments.

FIG. 3 is a call diagram illustrating different times at which the wireless communication device selectively starts a timing advance timer according to different embodiments.

FIG. 4 is a logic flow diagram illustrating different conditions on which the wireless communication device bases its selective start of the timing advance timer, according to one or more embodiments.

FIG. 5 is a logic flow diagram of a method implemented by a radio access node in the wireless communication network of FIG. 1, according to one or more embodiments.

FIGS. 6A and 6B are logic flow diagrams illustrating different embodiments for implicitly indicating whether or not the wireless communication device is to start a timing advance timer while forming a timing advance group.

FIG. 7 is a logic flow diagram of a method implemented by a wireless communication device in the wireless communication network of FIG. 1, according to one or more other embodiments.

FIG. 8 is a block diagram of a wireless communication device configured according to one or more embodiments.

FIG. 9 is a block diagram of one or more control circuits of the wireless communication device configured to implement the method shown in FIG. 2, according to one or more embodiments.

FIG. 10 is a block diagram of one or more control circuits of the wireless communication device configured to implement the method shown in FIG. 7, according to one or more embodiments.

FIG. 11 is a block diagram of a radio access node configured according to one or more embodiments.

FIG. 12 is a block diagram of one or more control circuits of the radio access node configured to implement the method shown in FIG. 5, according to one or more embodiments.

### DETAILED DESCRIPTION

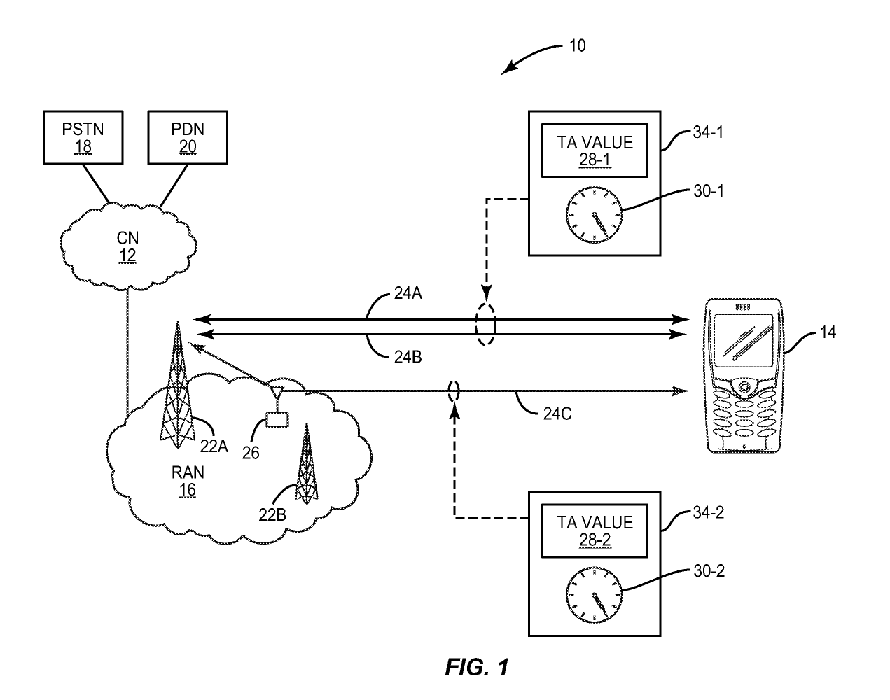

FIG. 1 depicts a wireless communication network 10. The network 10 comprises a core network (CN) 12 that connects wireless communication devices (one of which is shown as device 14) to one or more external networks via a radio access network (RAN) 16. The one or more external networks are shown in FIG. 1 as a public switched telephone network (PSTN) 18 and a packet data network (PDN) 20 such as the Internet.

The RAN 16 includes a plurality of radio access nodes 22, two of which are shown as nodes 22A and 22B. Each radio access node 22 terminates one or more cells 24 on which transmissions are performed for communicating with wireless communication devices. A cell 24 in this regard refers to a defined set of radio resources, such as a carrier frequency, for wirelessly communicating over a defined geographic region. For example, in embodiments where the wireless communication network 10 conforms to Long Term Evolution (LTE) Release 11 specifications, the radio access nodes 22 comprise enhanced Node B's (eNodeB's) that each terminates one or more cells 24 (also referred to as component carriers). Regardless, the RAN 16 may further include one or more repeaters 26 that are configured to relay one or more cells 24 between a radio access node 22 and wireless communication devices.

A wireless communication device in the network 10 may be configured to perform uplink transmissions on multiple cells 24 at the same time, e.g., by employing carrier aggregation. In this case, the device maintains different timing advance (TA) values 28 and corresponding timing advance timers 30 for different groups 32 of cells 24 that are associated with different round trip times (e.g., because the different groups 32 are terminated at different radio access nodes 22, are in different frequency bands, are relayed by a different number of repeaters 26, or the like). These groups 32 are referred to as timing advance groups. The device performs uplink transmissions on the cells 24 in any given timing advance group 32 according to the timing advance value 28 maintained for that group 32, provided that the corresponding timing advance timer 30 has not expired. This way, the device's uplink transmissions on a cell 24 in the group 32 will arrive at a radio access node 22 terminating that cell 24 aligned in time with other devices' uplink transmissions on the cell 24.

FIG. 1, as just one example, shows a wireless communication device 14 as being configured to perform uplink transmissions on cell 24A, cell 24B, and cell 24C at the same time. The cells 24A, 24B, and 24C are each terminated by radio access node 22A, but cell 24C is relayed by a repeater 26 and is thus associated with a longer round trip time than cells 24A and 24B. Accordingly, the device 14 forms two different timing advance groups 32-1 and 32-2. The device 14 forms group 32-1 to include cells 24A and 24B, and performs uplink transmissions on those cells 24A, 24B according to a timing advance value 28-1 maintained for that group 32-1, provided that the corresponding timing advance timer 30-1 has not expired. Similarly, the device 14 forms group 32-2 to include cell 24C, and performs uplink transmissions on cell 24C according to a different timing advance value 28-2 maintained for that group 32-2, provided that the corresponding timing advance timer 30-2 has not expired. Although not shown, the device 14 may also be configured to perform uplink transmissions on one or more cells 24 that are terminated by a different radio access node 22B and that are included in a different timing advance group 32.

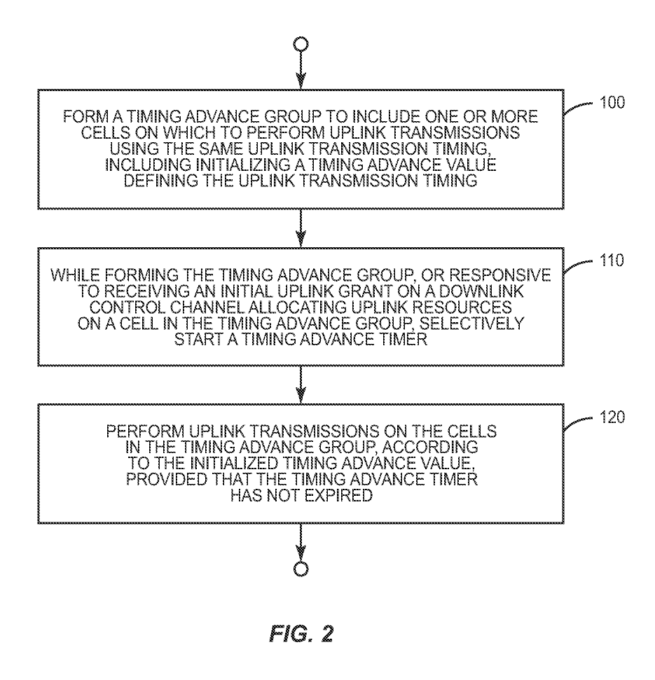

Regardless, the device 14 according to one or more embodiments is advantageously configured to start the timing advance timer 30 maintained for a given timing advance group 32 (e.g., group 32-2) at a different time and/or in a different way than known approaches. In doing so, the device 14 optimizes associated control signaling and/or reduces any delay between when the group 32 is formed and when the device 14 can perform non-random-access uplink transmissions on the cells 24 in the group 32. This in turn improves network performance and user experience. FIG. 2 illustrates processing performed by the device 14 in this regard, according to some embodiments.

As shown in FIG. 2, processing at the device 14 entails forming a timing advance group 32 to include one or more cells 24 on which to perform uplink transmissions using the same uplink transmission timing (Block 100). Forming the timing advance group 32 in this regard includes initializing a timing advance value 28 that defines the uplink transmission timing to be used for the group 32. While forming the timing advance group 32, or responsive to receiving an initial uplink grant on a downlink control channel allocating uplink resources on a cell 24 in the group 32, processing at the device 14 further entails selectively starting a timing advance timer 30 maintained for the group 32 (Block 110). Finally, processing at the device 14 includes performing uplink transmissions on the cells 24 in the group 32, according to the initialized timing advance value 28, provided that the timing advance timer 30 has not expired (Block 120).

Notably, selectively starting the timing advance timer 30 while forming the timing advance group, or responsive to receiving the initial uplink grant, enables the timer 30 to be started before non-random-access uplink transmissions are to begin and thereby minimizes any delay that might otherwise occur until the device 14 can perform those transmissions. Moreover, selectively starting the timer 30 in this way proves more efficient than known approaches in terms of downlink control signaling, because the device 14 is able to perform uplink transmissions on the cells 24 in the group 32 without having to receive a timing advance command in a random access response or in a MAC CE.

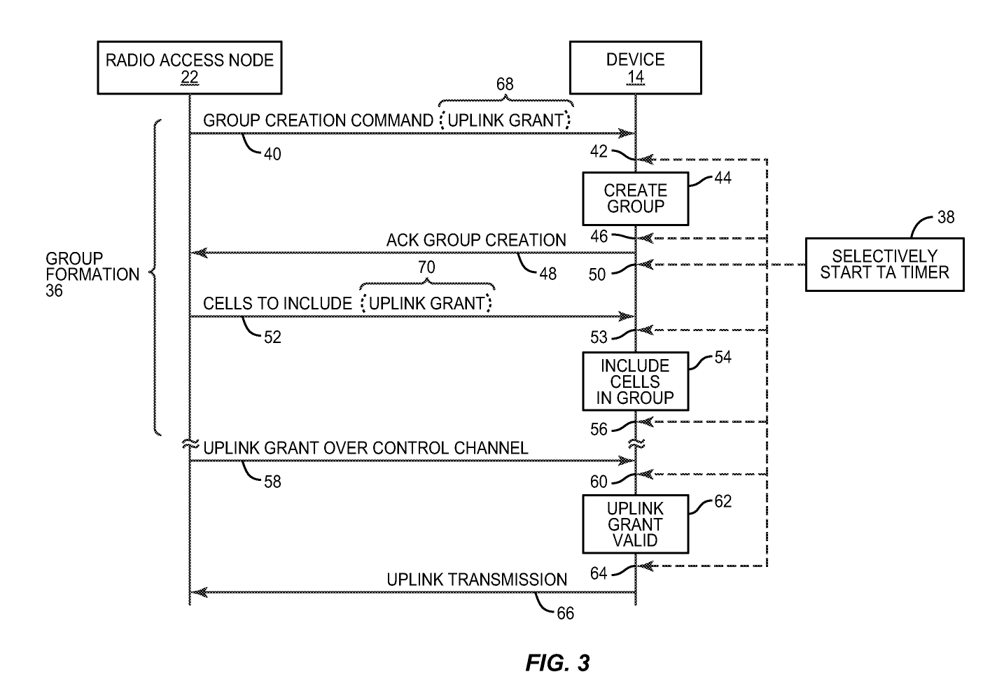

Note that, in embodiments where the device 14 selectively starts the timer 30 while forming the timing advance group 32, the timer 30 may be selectively started at any point during the group formation process. Forming a timing advance group 32 in some embodiments, for example, involves multiple steps and the timer 30 may be selectively started in conjunction with any one of those steps. FIG. 3 illustrates these group formation steps according to one or more embodiments.

As shown in FIG. 3, the group formation process 36 involves a radio access node 22 and the device 14 exchanging one or more messages that are associated with group formation. In some embodiments, for instance, these messages are exchanged via Radio Resource Control (RRC) signaling. Regardless, the device 14 may selectively start the timing advance timer 30 (Step 38) at any point during this process 36, such as in conjunction with the exchange of a particular message associated with group formation or in conjunction with the device's response to a particular message.

In more detail, FIG. 3 shows the group formation process 36 involves the radio access node 22 sending the device 14 a command to create a timing advance group 32 (Step 40). This command may, for instance, command the device 14 to create a data structure 34 (e.g., in the device's memory) to represent the timing advance group 32 being formed. The device 14 correspondingly creates this data structure 34 responsive to receiving the command (Step 44). In some embodiments, this data structure 34 holds an identifier that identifies the group 32 being formed, the timing advance value 28 for the group 32, the timing advance timer 30 for the group 32, and the timing reference associated with the timing advance value 28 or at least a pointer to such a reference. Upon creating the data structure 34 representing the group 32 being formed, the device 14 sends an acknowledgement to the radio access node 22 confirming that the data structure 34 has been created in accordance with the node's command (Step 48).

The radio access node 22 also indicates to the device 14 one or more cells 24 that are to be included in the group 32 being formed. For illustrative purposes, FIG. 3 shows that the node 22 indicates this in a message sent separately from a message including the group creation command (Step 52). Regardless, the device 14 includes these one or more cells 24 in the group 32 being formed (Step 54). In some embodiments, this entails adding identifiers for the one or more cells 24 to a list (e.g., an array) of cell identifiers held by the data structure 34 created for the group 32. In other embodiments, this entails updating pointers held by data structures that represent the respective cells 24 to point to the group 32 in which the cells 24 are included.

Regardless, the device 14 may selectively start the timing advance timer 30 (Step 38) at any point during this process 36. In some embodiments, for example, the device 14 selectively starts the timing advance timer 30 responsive to receiving the command (at Step 40) to create a data structure to represent the timing advance group 32, e.g., by performing Step 38 at point 42 during the group formation process 36. In some cases, though, the device 14 may not be configured to create the timing advance timer 30 until the device 14 actually creates the data structure to represent the group 32. In other embodiments, therefore, the device 14 selectively starts the timing advance timer 30 responsive to actually creating that data structure (at Step 44), e.g., by performing Step 38 at point 46. Note that, although the device 14 is shown in FIG. 3 as creating the data structure 34 responsive to the command from the radio network node 22, such need not be the case. In at least some embodiments, for instance, the device 14 is configured to autonomously decide to create such data structure 34. The device 14 may, for example, receive control signaling that indicates a given cell 24 is to be included within a timing advance group 32 for which the device 14 has not formed (i.e., for which the device 14 has no identifier). In this case, the device 14 autonomously decides to create a data structure 34 for such group 32 and to assign the indicated identifier to that group 32.

In still other embodiments, the device 14 selectively starts the timing advance timer 30 responsive to sending acknowledgement (at Step 48) that the data structure has been created, e.g., by performing Step 38 at point 50. These embodiments advantageously ensure that the timer 30 is not started until the network 10 becomes aware that the group 32 has been successfully created.

Of course, because the device 14 cannot perform uplink transmissions associated with the group 32 until one or more cells 24 are included in the group 32, yet other embodiments herein selectively start the timing advance timer 30 in conjunction with cells 24 being included in the group. In some embodiments, for example, the device 14 selectively starts the timing advance timer 30 responsive to receiving a message from the radio access node 22 indicating the one or more cells 24 to include in the timing advance group 32 (at Step 52), e.g., by performing Step 38 at point 53. In alternative embodiments, the device 14 selectively starts the timing advance timer 30 responsive to actually including the one or more cells 24 in the timing advance group 32 (at Step 54), e.g., by performing Step 38 at point 56.

Regardless of the particular point at which the device 14 selectively starts the timing advance timer 30 during the group formation process 36, that timer start point in at least some embodiments is the same as the point at which the device 14 initializes the timing advance value 28 during the formation process 36. As shown in FIG. 3, for example, the device 14 in some embodiments initializes the timing advance value 28 responsive to actually including one or more cells 24 in the group 32 being formed, i.e., at point 56, and also selectively starts the timing advance timer 30 at that point.

In other embodiments, though, the timer start point is different than the point at which the device 14 initializes the timing advance value 28 during the group formation process 36. For example, although FIG. 3 depicts the radio access node 22 signaling the one or more cells 24 to include in the group 32 at a point in time after the node 22 has already commanded the device 14 to create a data structure to represent the group 32, the node 22 in other embodiments indicates those cells 24 at the same time as it commands the device 14 to create the data structure, i.e., Step 52 occurs at approximately the same time as Step 40. The device 14 in this case is configured to include the one or more cells 24 in the group 32 in conjunction with creating the data structure to represent the group 32, i.e., Step 54 occurs at approximately the same time as Step 44. Furthermore, the device 14 is also configured to initialize the timing advance value 28 when creating the data structure. Thus, if the device 14 is configured to selectively start the timing advance timer 30 only upon acknowledging that the data structure has been created, the device 14 in these embodiments starts the timer 30 (at point 50) after it has initialized the timing advance value 28 (at Step 44).

In still other embodiments, the timer start point during the group formation process 36 is associated with the reception of one or more uplink grants during that process 36. Reception of one or more uplink grants during group formation proves more proactive than delaying the one or more uplink grants until after group formation, as is conventional, since the group 32 is presumably being created so that the device 14 can perform transmissions on one or more of the cells 24 in the group 32. In one or more embodiments, for example, the device 14 receives one or more uplink grants while forming the timing advance group 32, where the one or more uplink grants allocate uplink resources on a cell 24 in the group 32 being formed. Responsive to receiving these one or more uplink grants during the group formation process, the device 14 selectively starts the timing advance timer 30. Selectively starting the timer 30 responsive to the proactive reception of one or more uplink grants during group formation advantageously enables the timer 30 to be started before uplink transmissions are to begin and thereby minimizes any delay that might otherwise occur until the device 14 can perform uplink transmissions.

As shown in FIG. 3, the one or more uplink grants can be received during group formation in any number of ways. In some embodiments, for instance, one or more uplink grants 68 triggering the selective start of the timer 30 are received in a command to create the data structure 34 representing the group 32, i.e., at Step 40. In this case, reception of the one or more uplink grants in the command triggers the device 14 to selectively start the timer 30 at point 42. In other embodiments, by contrast, one or more uplink grants 70 triggering the selective start of the timer 30 are received in one or more messages indicating the cells 24 to include in the group 32, i.e., at Step 58. In this case, reception of the one or more uplink grants in the command triggers the device 14 to selectively start the timer 30 at point 53.

The advantages discussed above for starting the timing advance timer 30 in conjunction with reception of one or more uplink grants also apply to embodiments where those one or more uplink grants are received only after the group formation process, rather than during the process. Thus, the device 14 in some embodiments is configured to selectively start the timing advance timer 30 responsive to receiving an initial uplink grant on a downlink control channel after group formation. FIG. 3 illustrates an example of these embodiments as well.

As shown in FIG. 3, the radio access node 22 in these embodiments is configured to send the device 14 an initial uplink grant on a downlink control channel (Step 58), rather than in the one or more messages (40, 52) associated with group formation. A downlink control channel in this regard comprises, for instance, the Physical Downlink Control Channel (PDCCH) in embodiments where the network 10 conforms to LTE standards. Regardless, the initial uplink grant allocates uplink resources to the device 14 on one or more of the cells 24 that were included in the group 32 during group formation 36. Responsive to receiving such an uplink grant associated with the formed group 32, the device 14 selectively starts the timing advance timer 30 maintained for that group 32.

In some embodiments, selectively starting the timer 30 responsive to receipt of this uplink grant means selectively starting the timer 30 when the grant is received, i.e., at point 60. In other embodiments, though, selectively starting the timer 30 responsive to receipt of this uplink grant means selectively starting the timer 30 when a time occurs at which uplink transmissions are to be performed in accordance with that grant. As shown in FIG. 3, for instance, the grant received at Step 58 allocates resources to the device 14 for performing uplink transmissions at a later time, i.e., at time 64. Responsive to determining that this time is about to occur or is occurring (at Step 62), the device 14 selectively starts the timer 30 at time 64. In conjunction with starting the timer 30, the device 14 also performs the uplink transmissions for which it received the uplink grant (Step 66).

Of course, although the above description and FIG. 3 depict the device 14 as starting the timing advance timer 30 at a particular point in time in various embodiments, the actual start time of the timer 30 may practically vary depending on processing time or other real-world delays imposed on the device 14. Thus, the actual start time of the timer 30 may occur within a certain amount of time T1 after the points discussed above that depends on such delay. In at least some embodiments, the device 14 intelligently tracks or otherwise determines the amount of time T1 by which the start of the timer 30 has been delayed, and dynamically adjusts the duration D of the timer 30 as a function of that amount of time T1. In one embodiment, for example, the device 14 shortens the duration D of the timer 30 by T1 in order to compensate for the delay. In this case, therefore, the timer 30 still maintains an effective duration of D relative to the point in time that triggered the timer's start.

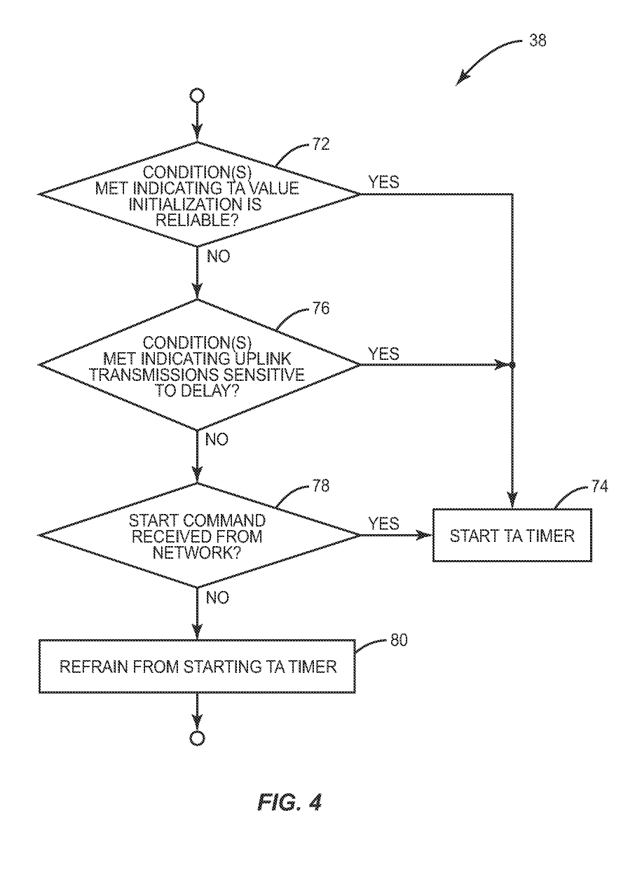

Irrespective of the particular time in FIG. 3 that the device 14 selectively starts the timing advance timer 30, selectively starting the timer 30 in at least some embodiments involves a determination by the device 14 as to whether or not to start the timer 30. Thus, if the device 14 is configured to selectively start the timer 30 at a particular time in FIG. 3, the device 14 in these embodiments makes a determination at that time as to whether or not to start the timer 30. Depending on that determination, the device 14 either starts the timer 30 at that time or refrains from starting the timer 30 at that time. FIG. 4 illustrates such selective timer start according to one or more embodiments.

As shown in FIG. 4, the selective starting of the timer 30 in FIG. 3 (Step 38), regardless of the point in time at which such occurs, involves one or more decisions. FIG. 4 depicts the decisions as being sequential, but this need not be the case. Indeed, the device 14 may be configured to perform any one of the decisions individually, or perform multiple ones of the decisions in combination (in any order).

With this understanding, FIG. 4 shows that the device 14 in some embodiments is configured to start the timing advance timer 30 (Block 74) if one or more defined conditions are met indicating that initialization of the timing advance value 28 is reliable (i.e., YES at block 72). Otherwise, the device 14 refrains from starting the timer 30 (Block 80) or, in at least some embodiments, determines whether one or more other conditions are met for starting the timer 30. In one embodiment, initialization proves reliable if the timing advance value 28 is initialized according to a rule in a defined subset of possible rules defined to yield reliable initialization.

Such a subset may include, for instance, a rule that initializes the timing advance value 28 to zero. Initializing the timing advance value 28 to zero proves reliable when the cells 24 being included in the group 32 are terminated at a radio access node 22 that is close to the device 14, e.g., within 78 meters. In embodiments where the network 10 conforms to LTE Release 11 standards, for example, remote radio heads (RRHs) have a cell radius of smaller than 78 meters, meaning that initialization of the timing advance value 28 for cells 24 terminated by such RRHs will be reliable.

The subset may alternatively or additionally include a rule that initializes the timing advance value 28 for the timing advance group 32 to be an offset version of the timing advance value 28 for a different timing advance group 32. Initializing the timing advance value 28 in this way proves reliable, for instance, when moving one or more cells 24 from an existing timing advance group 32 to a newly formed group 32. This may occur in the example of FIG. 1, where the device 14 is performing uplink transmissions on multiple cells 24A, 24B, 24C that are terminated by a radio access node 22 and that are included in an existing timing advance group (e.g., group 32-1), but then moves into the coverage area of a repeater 26 that is configured to relay a subset of those cells, i.e., cell 24C. In this case, the radio access node 22 commands the device 14 to form a new timing advance group 32-2 that is to include cell 24C. While forming this new group 32-2, the device 14 initializes the timing advance value 28-2 for the new group 32-2 according to a rule that defines that value 28-2 to be an offset version of the timing advance value 28-1 for the existing group 32-1, in order to reliably compensate for the propagation delay difference and the processing delay of the repeater 26. Reliably initializing the timing advance value 28-2 for the new group 32-2 according to this rule drives the device 14 to decide to start the timing advance timer 30-2 for that group 32-2, at the time in FIG. 3 that such decision is made.

Had the device 14 initialized the timing advance value 28-2 for the new group 32-2 according to a different rule that defines the value 28-2 to be the same as (i.e., a copy of) the timing advance value 28-1 for the existing group 32-1, the initialization would be less reliable. In this case, the device 14 would determine that the rule used for initialization is not included in the defined subset of reliable rules, meaning that the device 14 would decide to refrain from starting the timing advance timer 30-2 for that group 32-2, at the time in FIG. 3 that such decision is made. Instead, the device 14 would wait to start the timer 30-2 for the new group 32-2 until receiving a random access response or a MAC CE from the radio access node 22, as is conventional.

Of course, instead of defining the reliability of initialization in terms of the rule used for that initialization, the reliability may be defined in other ways as well. For example, in at least some embodiments, initialization is deemed reliable if the timing advance value 28 is initialized as a value in a subset of possible values defined to be reliable, e.g., a subset including zero.

FIG. 4 shows that the device 14 in some embodiments is alternatively or additionally configured to start the timing advance timer 30 (Block 74) if one or more defined conditions are met indicating that uplink transmissions on one or more cells 24 included in the timing advance group 32 are sensitive to delay (i.e., YES at block 76). Otherwise, the device 14 refrains from starting the timer 30 (Block 80) or, in at least some embodiments, determines whether one or more other conditions are met for starting the timer 30. In one embodiment, uplink transmissions on a cell 24 included in the group 32 are deemed to be sensitive to delay if the device 14 was already configured, prior to the group's formation, to perform uplink transmissions on at least one cell 24 included in the group 32. Indeed, such suggests that the device 14 presumably has ongoing uplink transmissions on that at least one cell 24 and that interruption or delay to those transmissions should be avoided.

In other embodiments, uplink transmissions on a cell 24 included in the group 32 are deemed to be sensitive to delay if the device 14 is using a service in a subset of services defined to be delay sensitive. Services included in this subset may include, for instance, real-time voice or multimedia services, while excluding web browsing services and the like.

In still other embodiments, uplink transmissions on a cell 24 included in the group 32 are deemed to be sensitive to delay if an amount of data in a buffer for uplink transmissions exceeds a defined threshold. In this regard, a small amount of data in the uplink buffer suggests that the transmission of that data is likely less delay sensitive.

FIG. 4 shows that the device 14 in yet other embodiments is alternatively or additionally configured to start the timing advance timer 30 (Block 74) in accordance with a command received from the network 10 (Block 78). If the command indicates that the device 14 is to start the timing advance timer 30 while forming the timing advance group 32, or responsive to the initial uplink grant 58, then the device 14 decides to start the timer 30, at the time in FIG. 3 that such decision is made. Otherwise, if the command indicates that the device 14 is to not start the timer 30, then the device 14 decides to refrain from starting the timer 30 (Block 80) or, in at least some embodiments, determines whether one or more other conditions are met for starting the timer 30.

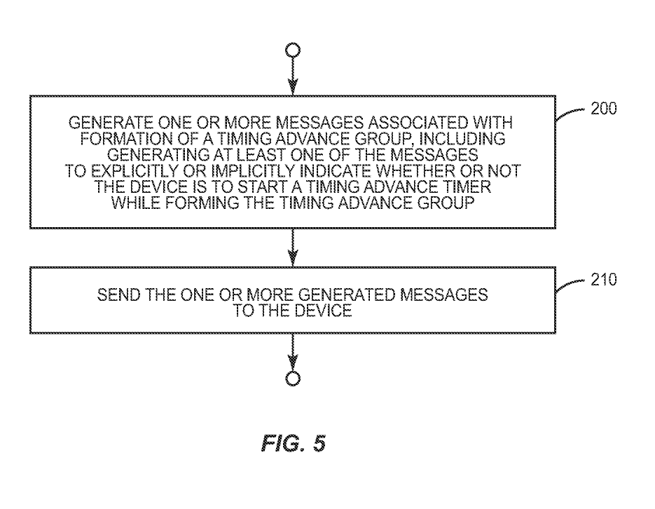

FIG. 5 illustrates corresponding processing performed by the radio access node 22 for sending such a command to the device 14 via control signaling associated with group formation. As shown in FIG. 5, processing at the node 22 entails generating one or more messages associated with formation by the wireless communication device 14 of a timing advance group 32 that includes one or more cells 24 on which to perform uplink transmissions using the same uplink transmission timing (Block 200). This includes generating at least one of those messages to explicitly or implicitly indicate whether or not the device 14 is to start a timing advance timer 30 while forming the timing advance group 32. Processing at the node 22 then entails sending the one or more generated messages to the device (Block 210).

In some embodiments, the message that indicates whether or not the device 14 is to start the timer 30 for the group 32 is the same message that commands the device 14 to create a data structure 34 to represent the group 32, i.e., the message at Step 40 in FIG. 3. In other embodiments, the message that indicates whether or not the device 14 is to start the timer 30 for the group 32 is the same message that indicates one or more cells 24 to be included in the group 32, i.e., the message at Step 52 in FIG. 3. Of course, as described above, a single message may indicate all of these things, e.g., in embodiments where Steps 40 and 52 in FIG. 3 are performed at the same time.

Regardless of the particular message in which the timer start indication is included, the message in some embodiments explicitly indicates whether or not the device 14 is to start the timer 30 as a field or flag dedicated to such indication.

In other embodiments, the message only implicitly indicates whether or not the device 14 is to start the timer 30. For example, in at least one embodiment the message explicitly indicates a mode in which the device 14 is to enter, or the conditions under which the device 14 is to enter that mode. This explicit indication, however, implicitly indicates whether or not the device 14 is to start the timer 30, because the device 14 is configured to start the timer 30 when in that mode.

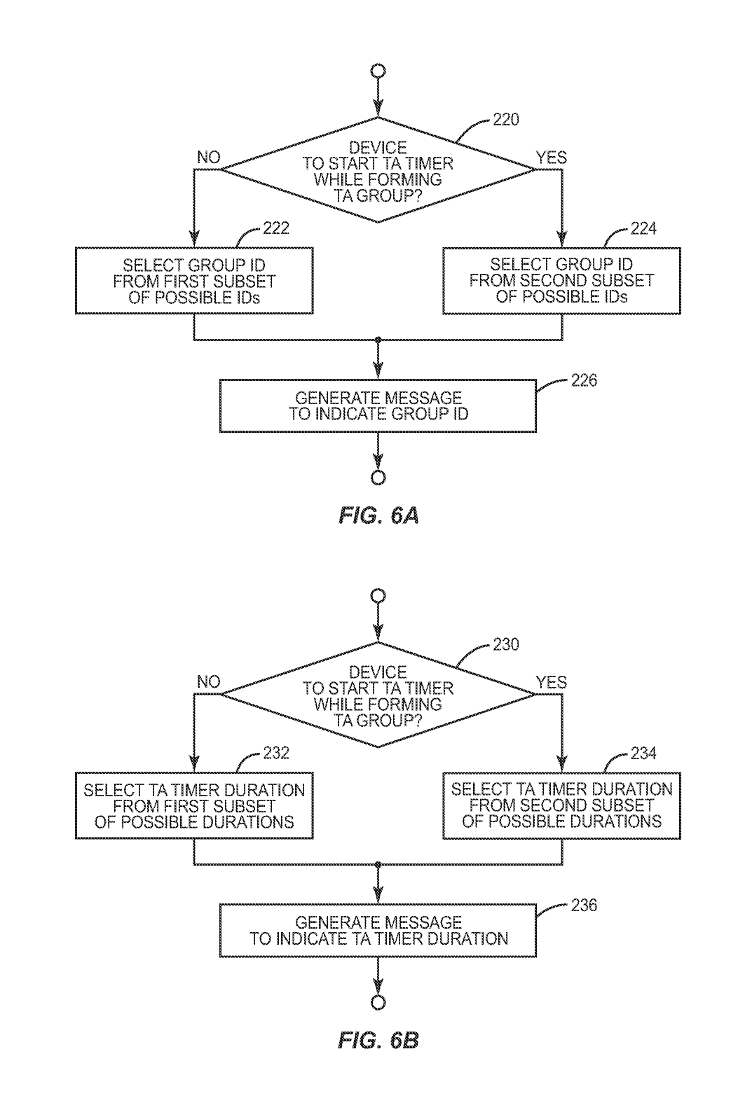

In alternative embodiments, the message uses different explicit indicators in order to implicitly indicate whether or not the device 14 is to start the timer 30 for a group 32 while forming that group 32. In one embodiment, for instance, the message explicitly indicates that the timing advance group 32 being formed is to be assigned an identifier in a subset of possible identifiers defined for indicating when the timing advance timer 30 for the group 32 is to be started. FIG. 6A illustrates one example of this embodiment.

As shown in FIG. 6A, the radio access node 22 determines whether or not the device 14 is to start the timing advance timer 30 for a timing advance group 32 while that group is being formed (Block 220). If the node 22 determines that the device 14 is not to start the timer 30 while the group 32 is being formed (NO at Block 220), then the node 22 selects an identifier for the group 32 being formed from a first subset of possible identifiers (Block 222). But if the node 22 determines that the device 14 is to start the timer 30 while the group 32 is being formed (YES at Block 220), then the node 22 selects an identifier for the group 32 being formed from a second subset of possible identifiers (Block 224). In either case, the node 22 then generates the message to indicate the selected identifier for the group 32 being formed. The device 14 is correspondingly configured to recognize the explicit indication of the group's identifier as implicitly indicating whether or not the device 14 is to start the timer 30 while the group 32 is being formed.

In a different embodiment, the message explicitly indicates that the timing advance timer 30 for the group 32 being formed is to have a duration in a subset of possible durations defined for indicating when the timing advance timer 30 for the group 32 is to be started. FIG. 6B illustrates one example of this embodiment.

As shown in FIG. 6B, the radio access node 22 determines whether or not the device 14 is to start the timing advance timer 30 for a timing advance group 32 while that group is being formed (Block 230). If the node 22 determines that the device 14 is not to start the timer 30 while the group 32 is being formed (NO at Block 230), then the node 22 selects a duration for the timing advance timer 30 for the group 32 being formed from a first subset of possible durations (Block 232). But if the node 22 determines that the device 14 is to start the timer 30 while the group 32 is being formed (YES at Block 220), then the node 22 selects a durationfor the timing advance timer 30 for the group 32 being formed from a second subset of possible durations (Block 224). In either case, the node 22 then generates the message to indicate the selected duration for the timer 30. The device 14 is correspondingly configured to recognize the explicit indication of the timer's duration as implicitly indicating whether or not the device 14 is to start the timer 30 while the group 32 is being formed.

In yet another embodiment, the message uses a different explicit indicator in order to implicitly indicate whether or not the device 14 is to start the timer 30 for a group 32 while forming that group 32. In this embodiment, the message explicitly indicates that uplink resources are allocated to the wireless communication device 14 on a cell 24 in the timing advance group. Such an uplink grant may, for instance, be sent at Step 40 or Step 52 of FIG. 3. Regardless, the device 14 is correspondingly configured to recognize the explicit indication of the uplink grant as implicitly indicating whether or not the device 14 is to start the timer 30 while the group 32 is being formed.

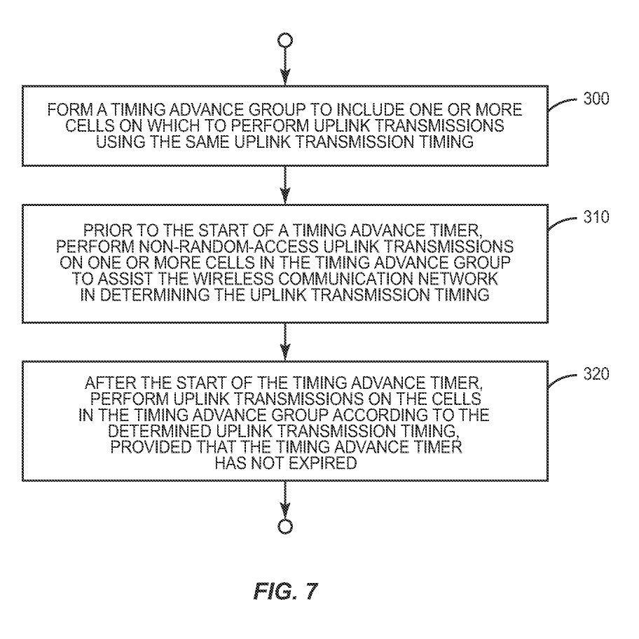

Although embodiments described above improve the time alignment process by starting the timing advance timer 30 for a timing advance group 32 at a different time and/or in a different way than known approaches, other embodiments herein improve the time alignment process by permitting select non-random-access uplink transmissions on the cells 24 in a group 32 even prior to the start of the timing advance timer 30. FIG. 7 illustrates processing performed by the device 14 in this regard, according to one or more embodiments.

As shown in FIG. 7, processing at the device 14 entails forming a timing advance group 32 to include one or more cells 24 on which to perform uplink transmissions using the same uplink transmission timing (Block 300). Processing also entails, prior to the start of a timing advance timer 30 for the group 32, performing non-random-access uplink transmissions on one or more cells 24 in the group 32 to assist the network 10 in determining the uplink transmission timing for the group 32 (Block 310). Processing then includes, after the start of the timing advance timer 30, performing uplink transmissions on the cells 24 in the group 32 according to the determined uplink transmission timing, provided that the timing advance timer 30 has not expired (Block 320).

In at least some embodiments, the non-random-access uplink transmissions performed prior to the start of the timer 30 are made on a defined subset of uplink channels or a defined subset of uplink signals. In this case, the device 14 is prohibited from performing non-random-access transmissions on other uplink channels or signals prior to the start of the timer 30. In one embodiment, for example, the device 14 is configured to perform non-random-access uplink transmissions by transmitting a channel-sounding reference signal (SRS) prior to the start of the timer 30, but is prohibited from performing other types of non-random-access uplink transmissions prior to the start of the timer 30. Regardless of the particular type of non-random-access uplink transmissions performed, though, the transmissions advantageously assist the network 10 in determining the uplink transmission timing for the group 32, without requiring the device 14 to perform random-access.

In at least some embodiments, the different approaches to improving the time alignment process (i.e., the approach described in FIGS. 1-6 and the approach described in FIG. 7) may be implemented separately and mutually exclusive of one another. In other embodiments, though, the different approaches may be implemented together. For example, in at least one embodiment, the device 14 is configured to selectively start the timing advance timer 30 for a group 32 responsive to receiving an initial uplink grant on a downlink control channel allocating uplink resources on a cell 24 in that group 32. Before receiving this initial grant and starting the timer 30, though, the device 14 performs non-random-access uplink transmissions as described above.

Those skilled in the art will appreciate that, while many of the above embodiments were described with reference to a particular timing advance group 32, the embodiments apply equally to any one of multiple different timing advance groups 32 formed by a wireless communication device 14. Those skilled in the art will further appreciate that a wireless communication device 14 herein may comprise a mobile terminal, a user equipment, a laptop computer, or the like. Also, no particular communication interface standard is necessary for practicing the present invention. The network 10, therefore, may be any one of a number of standardized network implementations, including Long Term Evolution (LTE), LTE-Advanced, or any other implementation supporting the grouping of cells 24 into timing advance groups 32.

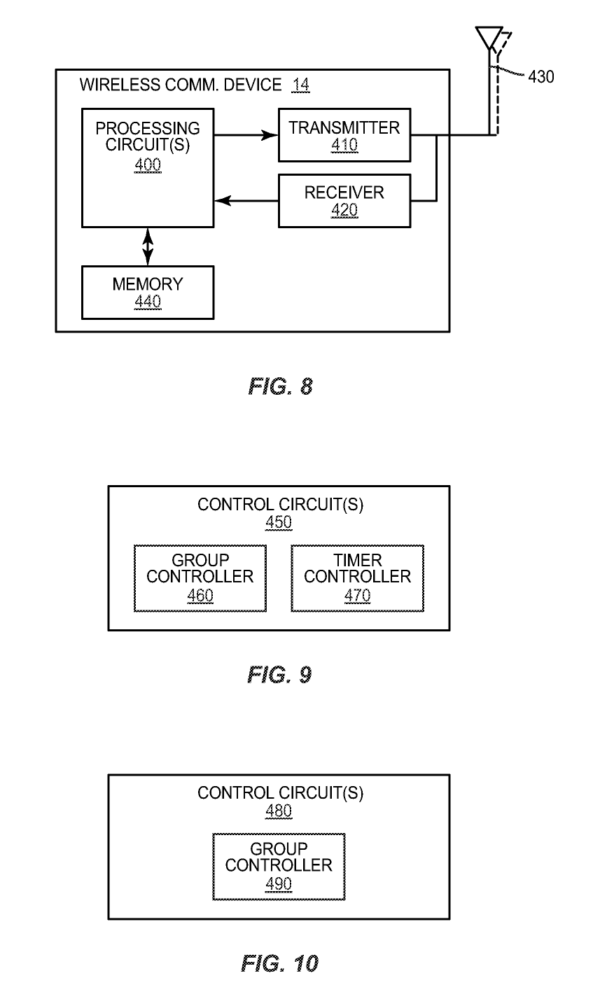

In view of the above modifications and variations, those skilled in the art will appreciate that FIGS. 8-12 illustrate corresponding apparatus configured to carry out one or more of the approaches described above. FIG. 8, for example, depicts a wireless communication device 14 configured to carry out one or more of the approaches. In particular, the device 14 may be configured to implement the methods illustrated in FIG. 2 or 7, or variants thereof. The device 14 includes one or more processing circuits 400, a transmitter 410, a receiver 420, one or more antennas 430, and a memory 440.

The transmitter 410 includes various radio-frequency components (not shown) for sending radio signals to the network 10, e.g., to a radio access node 22. More particularly, the transmitter 410 uses known radio processing and signal processing techniques, typically according to one or more telecommunications standards, and is configured to format digital data and condition a radio signal, from that data, for transmission over the air via the one or more antennas 430. Similarly, the receiver 420 is configured to convert radio signals received via the antenna(s) 430 into digital samples for processing by the one or more processing circuits 400. The one or more processing circuits 400 extract data from signals received via the receiver 420 and generate information for transmission via the transmitter 410.

The one or more processing circuits 400 comprise one or several microprocessors, digital signal processors, and the like, as well as other digital hardware. Memory 440, which may comprise one or several types of memory such as read-only memory (ROM), random-access memory, cache memory, flash memory devices, optical storage devices, etc., stores program code for executing one or more telecommunications and/or data communications protocols and for carrying out one or more of the techniques described herein. Memory 440 further stores program data, user data, and also stores various parameters and/or other program data for controlling the operation of the device 14.

Of course, not all of the steps of the techniques described herein are necessarily performed in a single microprocessor or even in a single module. Thus, FIG. 9 presents a more generalized view of a device control circuit 450 configured to carry out the method shown in FIG. 2. This control circuit 450 may have a physical configuration that corresponds directly to processing circuits 400, for example, or may be embodied in two or more modules or units. In either case, control circuit 450 is configured with a module or sub-circuit to carry out operations in accordance with the method in FIG. 2. This unit is pictured in FIG. 9 as including a group controller 460 and a timer controller 470.

The group controller 460 is configured to form a timing advance group 32 to include one or more cells 24 on which the wireless communication device 14 is to perform uplink transmissions using the same uplink transmission timing, including initializing a timing advance value 28 defining that uplink transmission timing. While forming the timing advance group 32, or responsive to receiving an initial uplink grant 58 on a downlink control channel allocating uplink resources on a cell 24 in the timing advance group 32, the timer controller 470 is configured to selectively start a timing advance timer 30. Finally, the transmitter 410 is configured to perform uplink transmissions on the cells 24 in the timing advance group 32, according to the initialized timing advance value 28, provided that the timing advance timer 30 has not expired.

FIG. 10 by contrast presents a more generalized view of a device control circuit 480 configured to carry out the method shown in FIG. 7. This control circuit 480 may also have a physical configuration that corresponds directly to processing circuits 400, for example, or may be embodied in two or more modules or units. In either case, control circuit 480 is configured with two or more modules or sub-circuits to carry out operations in accordance with the method in FIG. 7. These units are pictured in FIG. 10 as a group controller 490.

The group controller 490 is configured to form a timing advance group 32 to include one or more cells 24 on which to perform uplink transmissions using the same uplink transmission timing. Correspondingly, prior to the start of a timing advance timer 30, the transmitter 410 is configured to perform non-random-access uplink transmissions on one or more cells 24 in the timing advance group 32 to assist the wireless communication network 10 in determining the uplink transmission timing. Then, after the start of the timing advance timer 30, the transmitter 410 is configured to perform uplink transmissions on the cells 24 in the timing advance group 32 according to the determined uplink transmission timing, provided that the timing advance timer 30 has not expired.

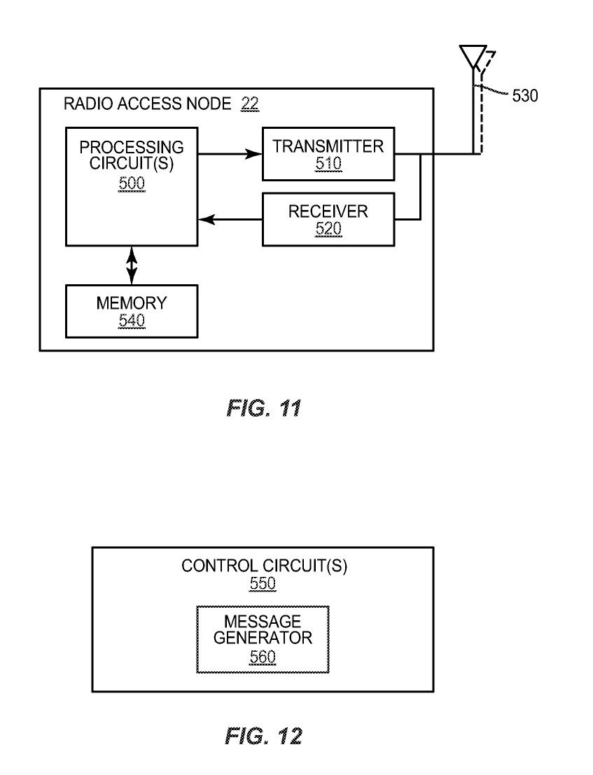

FIG. 11 depicts a radio access node 22 configured to carry out one or more of the approaches. In particular, the node 22 may be configured to implement the method illustrated in FIG. 5, or variants thereof. The node 22 includes one or more processing circuits 500, a transmitter 510, a receiver 520, one or more antennas 530, and a memory 540. These components of the radio access node 22 may be generally described in much the same way as described above with respect to FIG. 8.

FIG. 12 presents a more generalized view of a radio access node control circuit 550 configured to carry out the method shown in FIG. 5. This control circuit 550 may have a physical configuration that corresponds directly to processing circuits 500, for example, or may be embodied in two or more modules or units. In either case, control circuit 550 is configured with a module or sub-circuit to carry out operations in accordance with the method in FIG. 5. This unit is pictured in FIG. 12 as including a message generator 560. The message generator 560 is configured to generate one or more messages associated with formation by the wireless communication device 14 of a timing advance group 32 that includes one or more cells 24 on which to perform uplink transmissions using the same uplink transmission timing. This includes generating at least one of those messages to explicitly or implicitly indicate whether or not the device 14 is to start a timing advance timer 30 while forming the timing advance group 32. The transmitter 510 is configured to then send the one or more generated messages to the device 14.

Those skilled in the art will recognize that the present invention may be carried out in other ways than those specifically set forth herein without departing from essential characteristics of the invention. The present embodiments are thus to be considered in all respects as illustrative and not restrictive, and all changes coming within the meaning and equivalency range of the appended claims are intended to be embraced therein.

1-19. (canceled)

20. A method implemented by a wireless communication device in a wireless communication network that comprises a plurality of cells, the method comprising:
forming a timing advance group to include one or more cells on which to perform uplink transmissions using the same uplink transmission timing, said forming including initializing a timing advance value defining said uplink transmission timing;
while forming the timing advance group, or responsive to receiving an initial uplink grant on a downlink control channel allocating uplink resources on a cell in the timing advance group, selectively starting a timing advance timer; and
performing uplink transmissions on the cells in the timing advance group, according to the initialized timing advance value, provided that the timing advance timer has not expired.

21. The method of claim 20, wherein said forming comprises creating a data structure to represent the timing advance group, and wherein said selectively starting comprises selectively starting the timing advance timer while forming the timing advance group, by selectively starting the timing advance timer responsive to either:
receiving a command from the wireless communication network to create said data structure;
creating said data structure; or
sending acknowledgement to the wireless communication network that said data structure has been created.

22. The method of claim 20, wherein said forming comprises including the one or more cells in the timing advance group, and wherein said selectively starting comprises selectively starting the timing advance timer while forming the timing advance group, by selectively starting the timing advance timer responsive to including the one or more cells in the timing advance group.

23. The method of claim 20, further comprising, while forming the timing advance group, receiving one or more uplink grants allocating uplink resources on one or more cells in the timing advance group, and wherein said selectively starting comprises selectively starting the timing advance timer while forming the timing advance group, by selectively starting the timing advance timer responsive to receiving said one or more uplink grants.

24. The method of claim 23, wherein the one or more uplink grants are received in either:
a command to create a data structure to represent the timing advance group; or
one or more messages that indicate one or more cells to include in the timing advance group.

25. The method of claim 20, wherein said selectively starting comprises selectively starting the timing advance timer responsive to receiving said initial uplink grant, by starting the timing advance timer either:
when said initial uplink grant is received; or
when a time occurs at which uplink transmissions are to be performed in accordance with the received initial uplink grant.

26. The method of claim 20, wherein selectively starting the timing advance timer comprises starting the timing advance timer if one or more defined conditions are met indicating that said initialization of the timing advance value is reliable.

27. The method of claim 26, wherein the one or more defined conditions indicating that said initialization is reliable comprise one or more of:
the timing advance value being initialized as a value in a subset of possible values defined to be reliable; and
the timing advance value being initialized according to a rule in a defined subset of possible rules defined to yield reliable initialization.

28. The method of claim 20, wherein selectively starting the timing advance timer comprises starting the timing advance timer if one or more defined conditions are met indicating that uplink transmissions on one or more cells included in the timing advance group are sensitive to delay.

29. The method of claim 28, wherein the one or more defined conditions indicating that said uplink transmissions are sensitive to delay comprise one or more of:
the wireless communication device having already been configured, prior to formation of the timing advance group, to perform uplink or downlink transmissions on at least one cell included in the timing advance group;
the wireless communication device using a service in a subset of possible services defined to be delay sensitive; and
an amount of data in a buffer for said uplink transmissions exceeding a defined threshold.

30. The method of claim 20, further comprising receiving a command from the wireless communication network indicating whether or not the wireless communication device is to start the timing advance timer while forming the timing advance group or responsive to said initial uplink grant, and wherein selectively starting the timing advance timer comprises starting the timing advance timer in accordance with the received command.

31. A wireless communication device configured to perform uplink transmission in a wireless communication network that comprises a plurality of cells, the wireless communication device comprising one or more processing circuits configured to:
form a timing advance group to include one or more cells on which the wireless communication device is to perform uplink transmissions using the same uplink transmission timing, including initializing a timing advance value defining said uplink transmission timing; and
while forming the timing advance group, or responsive to receiving an initial uplink grant on a downlink control channel allocating uplink resources on a cell in the timing advance group, selectively starting a timing advance timer; and
a transmitter configured to perform uplink transmissions on the cells in the timing advance group, according to the initialized timing advance value, provided that the timing advance timer has not expired.

32. A method implemented by a radio access node for configuring a wireless communication device to perform uplink transmissions in a wireless communication network that comprises a plurality of cells, the method comprising:
generating one or more messages associated with formation by the wireless communication device of a timing advance group that includes one or more cells on which to perform uplink transmissions using the same uplink transmission timing, said generating one or more messages including generating at least one of said messages to explicitly or implicitly indicate whether or not the wireless communication device is to start a timing advance timer while forming the timing advance group; and
sending the one or more generated messages to the wireless communication device.

33. The method of claim 32, wherein said generating further comprises generating said at least one message to also indicate at least one of:
that the wireless communication device is to create a data structure to represent the timing advance group; and
that one or more cells are to be included in the timing advance group.

34. The method of claim 32, wherein said generating comprises generating said at least one message to implicitly indicate whether or not the wireless communication device is to start the timing advance timer while forming the timing advance group, by generating said at least one message to explicitly indicate:
that the timing advance group is to be assigned an identifier in a subset of possible identifiers defined for indicating when the timing advance timer is to be started;
that the timing advance timer is to have a duration in a subset of possible durations defined for indicating when the timing advance timer is to be started; or
that uplink resources are allocated to the wireless communication device on a cell in the timing advance group.

35. A radio access node for configuring a wireless communication device to perform uplink transmissions in a wireless communication network that comprises a plurality of cells, the radio access node comprising:
one or more processing circuits configured to generate one or more messages associated with formation by the wireless communication device of a timing advance group that includes one or more cells on which to perform uplink transmissions using the same uplink transmission timing, including generating at least one of said messages to explicitly or implicitly indicate whether or not the wireless communication device is to start a timing advance timer while forming the timing advance group; and
a transmitter configured to send the one or more generated messages to the wireless communication device.

36. A method implemented by a wireless communication device in a wireless communication network that comprises a plurality of cells, the method comprising:
forming a timing advance group to include one or more cells on which to perform uplink transmissions using the same uplink transmission timing;
prior to the start of a timing advance timer, performing non-random-access uplink transmissions on one or more cells in the timing advance group to assist the wireless communication network in determining said uplink transmission timing; and
after the start of the timing advance timer, performing uplink transmissions on the cells in the timing advance group according to the determined uplink transmission timing, provided that the timing advance timer has not expired.

37. The method of claim 36, wherein performing non-random-access uplink transmissions comprises transmitting a channel-sounding reference signal.

38. A wireless communication device in a wireless communication network that comprises a plurality of cells, comprising:
one or more processing circuits configured to form a timing advance group to include one or more cells on which to perform uplink transmissions using the same uplink transmission timing; and
a transmitter configured to:
prior to the start of a timing advance timer, perform non-random-access uplink transmissions on one or more cells in the timing advance group to assist the wireless communication network in determining said uplink transmission timing; and
after the start of the timing advance timer, perform uplink transmissions on the cells in the timing advance group according to the determined uplink transmission timing, provided that the timing advance timer has not expired.
